(19) United States
(12) Patent Application Publication
(10) Pub. No.: US 2004/0111398 A1
(43) Pub. Date: Jun. 10, 2004

(54) Performance mechanism for presenting integrated information in a graphical user interface

(75) Inventors: Laurence Edward England, Morgan Hill, CA (US); Chenhong Xia, San Jose, CA (US)

Correspondence Address: SUGHRUE MION, PLLC, 2100 PENNSYLVANIA AVENUE, N.W., SUITE 800, WASHINGTON, DC, 20037, US

(73) Assignee: International Business Machines Corporation, Armonk, NY

(21) Appl. No.: 10/314,471

(22) Filed: Dec. 9, 2002

(51) Int. Cl. G06F 7/00

(52) U.S. Cl. 707/3

(57) ABSTRACT

The invention relates to methods and apparatus for improving the performance of an integrated Graphical User Interface (GUI) client that presents an integrated view of model information originating from distributed information sources. Performance is enhanced by mapping the integrated GUI display components to replicated model information stored locally on the integrated GUI client. Replicated model information is maintained using information updates pushed from remote information sources to the integrated GUI client based upon a set of demand information mapping rules created based on the client's demand request. The load placed on the network to support an integrated display is distributed over time, thereby reducing spikes in network traffic associated with conventional integrated GUI approaches. Integrated GUI performance is improved regardless of the number of information sources, regardless of the number of queries to remote information sources, and regardless of network/processor latency, including delays due to traffic congestion and/or device failure.

### BACKGROUND OF THE INVENTION

1. Field of the Invention

The invention relates to information retrieval and presentation systems. More particularly, it relates to new techniques for the efficient retrieval, integration and presentation of distributed information via an integrated Graphical User Interface (GUI).

2. Description of the Related Art

Slow Graphical User Interface (GUI) performance is a problem typically associated with conventional GUI clients that present an integrated information display based upon information retrieved from multiple remote information sources, such as from different databases. The slow performance is often due to the time required for the GUI client to refresh the information that supports the integrated information display. Such refreshes are typically executed by issuing one or more queries from the GUI client across the network to the respective remote information sources. In a conventional GUI client application, such refreshes are processed in a “lazy access” manner, meaning that queries for information are sent to information sources only after a request to view the information is received.

Furthermore, given that such query based updates are typically executed across a Local Area Network (LAN), Wide Area Network (WAN) and/or Internet based network, slow GUI client performance can be further degraded by network latency. Network latency is typically introduced by a network connection, over which one or more queries must be serviced, that includes one or more low bandwidth and/or congested links. The likelihood of encountering such network delays is increased due to current commercial trends towards increased reliance upon shared enterprise resources (e.g., servers, databases, communication equipment, etc.) and the use of WAN and Internet links within enterprise communication networks to logically integrate multiple, physically dispersed shared resources.

Even if network bandwidth is sufficient the shared resources to which the queries are directed are often burdened with executing multiple application programs supporting hundreds, if not thousands, of users. Use of shared resources often guarantees that some delay will be the result of a delay in a remote information resource processing a query.

For example, in a typical enterprise information integration scenario, an end-to-end solution is required that is capable of presenting information that originates from multiple, physically dispersed information sources via an integrated GUI display. Requirements for integrated GUI displays are based on such integrated displays being more user-friendly because they present information from multiple sources within a single integrated display, rather than across multiple separate displays, or even multiple separate applications. However, since the information mapped to such user-friendly integrated GUI displays is often stored in multiple locations, physically dispersed throughout the enterprise or multiple enterprises, the delays associated with using such integrated GUI's often become operationally unacceptable. In many instances conventional integrated GUI displays are not practical due to the inherent latency associated with refreshing the information that the integrated GUI was explicitly required and designed to display. Many an enterprise integration effort has been abandoned due to operationally unacceptable GUI performance delays due, primarily, to the technical issues identified above.

Hence, there remains a strong need for methods and apparatuses that mitigate the effect of network and processing delays that occur in conventional integrated GUI display processing. Further, there is a strong need for an integrated GUI display that is capable of presenting a rapid response, integrated display of information received from multiple remote information sources, regardless of the number of information sources required to support the display, regardless of the number of queries required to refresh information received from each of the information sources, and regardless of latency introduced by any network and/or processor delay, including delays due to traffic congestion and device failure.

### SUMMARY OF THE INVENTION

Therefore, in light of the above, and for other reasons that will become apparent when the invention is fully described, methods and program products are described here for improving the performance of an integrated Graphical User Interface (GUI) client that presents an integrated view of model (data) information originating from one or more remote information sources. Performance is enhanced by mapping the integrated GUI display components to replicated model information stored locally on the integrated GUI client. Replicated model information is maintained using information updates pushed from remote information sources to the integrated GUI client based upon a set of demand information mapping rules. Demand information mapping rules are created by a remote information source based upon demand request information received from a client that can include: metadata describing information for which the client demands updates from the remote information source for an identified recipient; the identity of the identified recipient, typically, but not limited to, the client itself; and, authentication information (e.g., identity/password, digital signature, etc.) for the intended recipient of the requested updates. The demand request metadata and authentication information transmitted to a remote information source results in the remote source creating and storing upon the remote information source a set of demand information mapping rules for the update recipient identified in the demand request. These demand information mapping rules define a relationship between a remote information source and a local integrated GUI client. In one non-limiting representative embodiment, a demand request to a remote information source results in a handshaking process between the intended recipient and the remote information source during which the intended recipient (i.e., integrated client) is authenticated and a level of trust is established between the remote information server and the integrated GUI client, thus enabling the remote information source to determine what information, from that requested in the demand request, the integrated GUI client is entitled to receive.

Using the techniques described here, integrated GUI performance can be improved regardless of the number of information sources required to support the display, regardless of the number of queries required to each remote information source, and regardless of latency introduced by any network/processor delays, including delays due to traffic congestion and device failure. The GUI client can present the integrated information readily from its local replicated model information, rather than waiting for all the result sets from last minute queries to be returned across the network.

The local replicated model information is maintained by an replication module executing on each of the respective remote information sources which transmits information to the respective integrated GUI clients based on the demand information mapping rules. The demand information mapping rules can include a definition of a subset of remote information source data that is to be replicated on a specified integrated GUI client, the format of the update message, and update message timing information. Typically, information change (delta) is replicated to recipients immediately after the change occurs at the information sources, however, the demand mapping rules can include other update triggers/trigger delays based upon the needs of the intended integrated GUI client. Each respective remote information source diligently pushes replicated model information updates to the respective integrated GUI clients in accordance with instructions contained within the demand information mapping rules.

The above features and advantages of the invention will become apparent upon consideration of the following descriptions and descriptive figures of specific embodiments thereof. While these descriptions go into specific details of the invention, it should be understood that variations may and do exist and would be apparent to those skilled in the art based on the descriptions herein.

### BRIEF DESCRIPTION OF THE DRAWINGS

FIG. 1 is a non-limiting, representative system level block diagram of an asynchronous, integrated GUI display client and a representative system level block diagram of an asynchronous remote information source from which the integrated GUI display client receives a portion of the GUI information displayed.

FIG. 2 is a non-limiting, representative flow chart illustrating a handshaking process between an integrated GUI client and a remote information source that generates demand information mapping rules used to control diligent pushes of replicated model information updates from a remote information source to an integrated GUI client via asynchronous messaging updates.

FIG. 3 is a non-limiting, representative flow chart illustrating a process associated with an asynchronous, integrated GUI display client receiving information updates from a remote, asynchronous information source.

FIG. 4 is a non-limiting, representative flow chart illustrating a process associated with an asynchronous, integrated GUI display client initiating a pull operation to obtain critical last minute data changes not yet replicated from one or more remote, asynchronous information sources.

FIG. 5 is a non-limiting, representative flow chart illustrating a process associated with a remote information source receiving a request to update demand information mapping rules from an asynchronous, integrated GUI display client.

FIG. 6 is a non-limiting, representative flow chart illustrating a process associated with a remote information source diligently pushing asynchronous information updates to one or more asynchronous, integrated GUI display clients, in response to changes in the source information stored and in accordance with demand information mapping rules for the respective asynchronous, integrated GUI display clients.

### DETAILED DESCRIPTION

The embodiments described below are described with reference to the above drawings, in which like reference numerals designate like components.

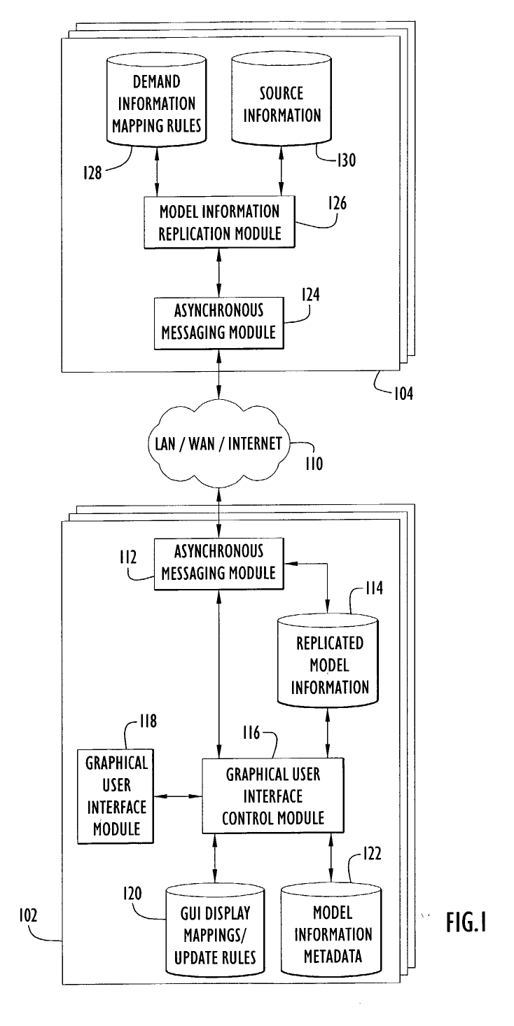

FIG. 1 depicts a non-limiting, representative system level diagram of one or more integrated Graphical User Interface (GUI) clients 102 connected, via a Local Area Network (LAN), Wide Area Network (WAN), or Internet based network 110, to one or more remote information sources 104. An integrated GUI client 102 communicates with a remote information source 104 via asynchronous messages transmitted between asynchronous messaging module 112 on a client and asynchronous messaging module 124 on a remote information source via network 110.

Components within the integrated GUI client 102 include the asynchronous messaging module 112 which communicates with a replicated model information store 114 and a GUI controller module 116. The GUI controller module 116 controls the presentation of information to a user via a graphical user interface module 118, based upon information stored within a GUI display mappings/update rules store 120, a model information metadata store 122 and the replicated model information store 114.

Components within an asynchronous remote information source 104 include the asynchronous messaging module 124 which communicates with a model information replication module 126 that has access to a non-volatile demand information mapping rules store 128 and a source information store 130.

An integrated GUI client 102 sends a demand request to a remote information source 104 that can include: metadata describing information for which the integrated GUI client 102 demands updates from the remote information source for an identified recipient, the identity of the identified recipient, typically, but not limited to, the client itself (as shown in FIG. 1); and, authentication information (e.g., identity/password/digital signature) for the intended recipient of the requested updates. The demand request metadata and authentication information transmitted to a remote information source 104 results in the model information replication module 112 creating and storing upon the remote information source a set of demand information mapping rules 128 for the update recipient identified in the demand request. These demand information mapping rules 128 define a relationship between a remote information source and an integrated GUI client. A demand request from an integrated GUI client 102 to a remote information source 104 results in a handshaking process between the intended recipient and the remote information source 104 during which the intended recipient is authenticated and a level of trust is established between the remote information server 104 and the intended integrated GUI client 102 recipient, thus enabling the remote information source 104 to determine what information, from that requested in the demand request, the integrated GUI client 102 is entitled to receive.

The source information store 130 contained within each remote information source 104, contains information that the remote information source 104 makes available to the integrated GUI clients 102. A demand request, as described above, requests updates for an identified subset of the source information 130 maintained upon the remote information source 104. The subset of information for which a client requests updates is typically a software representation of a physical, or logical, entity and can therefore be referred to as model information. This subset (or model) information received by an integrated GUI client 102 from a remote information source as the result of a demand request is stored on the integrated GUI client within a replicated model information store 114. By way of non-limiting example, information pertaining to a specific “checking account” could be identified as subset of information from a financial banking remote information store. Such an entity can be modeled in software by such attributes as an account number, an ‘owner’, a balance, etc, and it can have various operations that are performed against the account, such as open, close, credit, debit, etc.

Metadata describing the type and structure of local replicated model information 114 is stored by the integrated GUI client in the model information metadata store 122. Demand information mapping rules in a remote information source 104 are stored by the remote information source 104 in a non-volatile demand information mapping rules store 128. In this manner, a non-volatile data sharing relationship is established between an integrated GUI client 102 and a remote information source 104.

An integrated GUI client 102 can establish such data sharing relationships with multiple remote information sources 104, and thereby obtain sufficient replicated model information to support the display of complex integrated GUI displays based upon the local replicated model information. GUI refreshes, and/or changes in view information, therefore, can be generated locally, without requiring GUI information to be refreshed using high-latency cross-network queries used by conventional integrated client GUI's, thereby vastly improving GUI performance.

Further, a remote information source 104 can establish such data sharing relationships with multiple integrated GUI clients 102. An individual remote information source 104 monitors changes made to information within its source information store 130. When a change is detected, the module information replication module 126 searches the demand information mapping rules 128 to determine if the changes affect any replicated information stored upon an integrated GUI client 102 with which it has an established data sharing relationship. If so, and update conditions for sending an update are met, change information is formatted and transmitted to the integrated GUI client identified in the respective demand information mapping rule. Depending upon the number of integrated GUI clients 102 that have submitted demand information mapping rules for the affected information, the remote information source 104 may generate and transmit multiple asynchronous update messages based upon a single change, or set of changes, to its information store 130. In this manner a single remote information source 104 can support numerous integrated GUI displays associated with one or more applications on multiple integrated GUI clients 102 from a single information store 130.

In one representative embodiment, asynchronous messaging is used for communications between remote information sources 104 and integrated GUI clients 102. Use of asynchronous messaging to replicate information from multiple remote information sources to a local information store on an integrated GUI client has many advantages over conventional integrated GUI display techniques. By using asynchronous messaging techniques, the integrated GUI display is temporally decoupled from operations associated with the maintenance of the information that supports the integrated GUI display, resulting in numerous benefits. First, GUI display refreshes, and/or changes in view information can be generated based upon locally stored replicated model information, thereby avoiding high-latency cross-network queries used by conventional integrated client GUI's. Second, once an integrated GUI client 102 submits a set of demand information mapping rules to one or more remote information sources 104, maintenance of the replicated model information 114 is relatively transparent. Third, because updates to the replicated model information 114 are generated as changes occur, the load placed on the network to support an integrated display is distributed over time, thereby reducing spikes in network traffic associated with conventional integrated GUI approaches, previously described. Fourth, asynchronous updates to the replicated model information 114 are issued by remote information sources 104 in accordance with an update policy established by the client itself. Therefore, network load associated with supporting an integrated display on a local integrated GUI client 102 can be based upon a variety of conditions including: accuracy needs of the specific integrated GUI display and/or capacity/congestion of links associated with a specific remote information source 104, thereby accommodating operational considerations while assuring adequate availability of information at an integrated GUI client. Fifth, because the update messages are received asynchronously and are distributed over a broader period of time, an increase in the number of remote information sources supporting an individual integrated display does not impact GUI performance. Sixth, because the GUI display is refreshed based upon locally stored data, congestion or temporary loss of one or more remote information source links, while it may affect the accuracy of information presented, does not impact GUI performance. Seventh, using asynchronous messaging service in which undeliverable messages remain queued in an asynchronous message queue, an integrated GUI client is more likely to receive asynchronous information updates to its local replicated model information store, even if the integrated GUI client is temporarily out of service and unreachable. Eighth, the asynchronous message from a remote information source can be configured to carry a time stamp that can be used by the GUI client to decide whether a new query to the remote information source is necessary, based upon the client's update rules. Such time stamp information can also be displayed on the GUI client to the user, so that the user is informed of the accuracy of the displayed information (e.g., checking account information updated within the last two minutes may be as accurate as necessary for a user who doesn't make deposits or withdrawals on a minute by minute basis).

Once an information source server 104 sends the requested model information to an integrated GUI client via an initial transfer, future updates (i.e., updates in response to a change in the source information 130) need only to send the change itself (delta) to the recipient through a replication module 126. In this manner, the remote information source 104 replicates data changes to the integrated GUI client 102 whenever a change occurs. Therefore, the integrated GUI client can use the accumulated updates in the local replicated model store 114 to refresh the GUI display, instead of having to send queries in the last moment to collect information and wait for all query results return from all information servers the requests were sent to, before it can refresh the GUI display

Table 1, below, presents non-limiting, representative categories of information typically stored in a demand information mapping rule store 128 on an integrated GUI client 102. As shown in Table 1, the demand information mapping rule store relates a network (or logical) address of a recipient integrated GUI client (Recipient Destination) with an explicitly identified subset of information upon the remote information source (Available Information Resource), identified by the requesting client and Authentication Information used by the remote information source to validate that the information updates requested comply with security requirements. In addition, the demand information mapping rule store can optionally specify for one or more mapping rules: a condition/criteria or threshold condition (e.g., change value exceeds threshold, change value below threshold, any change, etc.) that prompts generation of an update message to the associated integrated GUI client; an update message content format for use in conveying change information (e.g., delta change only, changed field, changed table, etc.); and/or, an update message time factor (e.g., update immediately upon change, delay update for a period of time after a change has occurred, update after a specified number of changes have occurred, etc.) that controls when an update message is to be generated once a condition or criteria has been met.

TABLE 1
Representative Demand Information Mapping Rule Data -

| | | Available | | Update | Update |
|---|---|---|---|---|---|
| Recipient | Authentication | Information | Condition/ | Message | Message |
| Destination | Info. | Resource | Criteria | Content Format | Time Factor |
| IP Address | UserID/password | Table name | Value Exceeds | Change Only | Immediate at |
| (or resolvable | | | Threshold | (delta) | Change |
| logical addr/domain) | | | | | |
| Recipient ID | Digital Signature | Table name/ | Value Below | Change Only | Change + |
| | and heartbeat | Table Field | Threshold | (delta) | Delay |
| | signal | | | Changed Fields | |
| IP Address/server | Application | Table name/ | Any Change | Change Only | Periodic |
| | identifier/one | Table Row | | (delta) | |
| | time password | Criteria | | | |
| IP Address/server/ | Encrypted Client | Defined Query | Changed | All columns | After N |
| application name | ID and heartbeat | | Query Results | requested | changes |
| | signal | | | | |
| IP Address/server/ | Authenticated | Defined View/ | Model | Full refresh | Only when |
| application instance | heartbeat signal | Report/Listing | Changed | | client is |
| | | | | | restarted |

Table 2, below, presents non-limiting, representative categories of information typically stored in a GUI display mappings/update rules store 120 of an integrated GUI client 102. As shown, the GUI display mappings/update rules store relates a displayed GUI component (e.g., window, dialog, list box, text box, combo box, etc) with a replicated model information data source from the local replicated model information store 114. In addition, the GUI display mappings/update rules store 120 specifies update rules associated with a displayed GUI component that govern when the component is updated in the GUI display. The GUI display mappings/update rules store can optionally specify additional useful information such as data types associated with a mapped resource (e.g., numeric, text, string, matrix/array).

TABLE 2
GUI Display Mapping/Update Rules -

| Integrated GUI | Replicated Model | | |
|---|---|---|---|
| Component | Information | Data Type | Update Rules |
| Static Field | Table name/ | SQL Type | Remote Refresh Prior |
| | Table Field name | Definition | to Initial Display |
| Window | Table | Text/String | Immediate Upon |
| | | | Notification of Change |
| List Box | Query name | Numeric | Notification of |
| | | | Change + Delay |
| Combo Box | View Name | Matrix/Array | Periodic Refresh |
| | | | Period User initiated |
| | | | refresh |
| Editable Text | Report/Listing | Enumerated | After N Change |
| | Name | Type | Notifications |

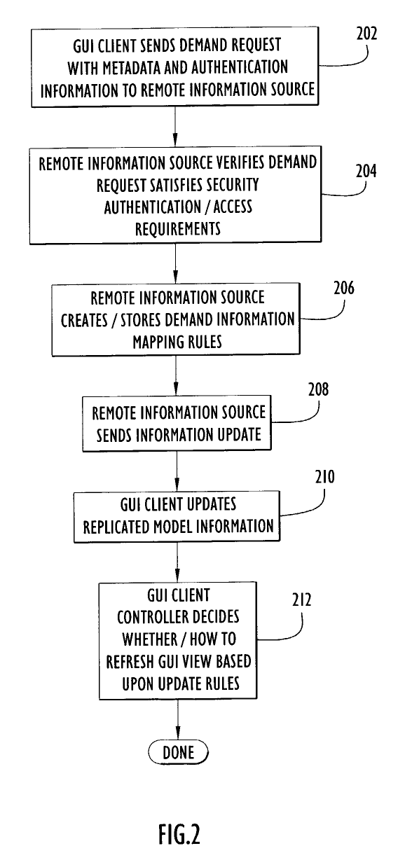

FIG. 2 is a non-limiting, representative flow chart illustrating a handshaking process between an integrated GUI client and a remote information source that generates demand information mapping rules used to control diligent pushes of replicated model information updates from a remote information source to an integrated GUI client via asynchronous messaging updates.

First, in operation 202, the integrated GUI client sends a demand request containing information update request metadata and authentication information to a remote information source. In response to receiving the request, a remote information source, in operation 204 validates the received authentication information and verifies that the demand request satisfies security requirements (e.g., authentication/access requirements) for the information updates requested. Upon verifying that security considerations have been met, in operation 204, the remote information source creates and stores a set of demand information mapping rules based upon the received demand request metadata, thus establishing a non-volatile relationship between the remote information source and the integrated GUI client and completing the client/remote information handshaking process, as previously described.

In response to a change in the source information maintained by the remote information source, in operation 208, the remote information source identifies and sends information updates to integrated GUI clients based upon the stored demand information mapping rules. Upon receipt of an information update message, an integrated GUI client, in operation 210 updates its replicated model information and, in operation 212, the GUI client controller decides whether, and how, to refresh the GUI view based upon the stored GUI update rules, as previously described, above, with respect to Table 2.

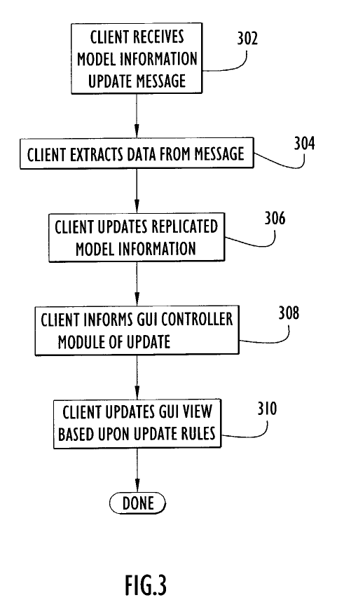

FIG. 3 is a non-limiting, representative flow chart illustrating a process associated with an integrated GUI display client receiving information updates from a remote information source. As previously described with respect to FIG. 1, once demand information mapping rules have been created, maintenance of the replicated model information store upon an integrated GUI client occurs in a manner relatively transparent to other integrated GUI operations via the periodic or asynchronous receipt of update messages from the respective remote information sources. As shown in FIG. 3, in processing each update, the integrated GUI client messaging module receives, in operation 302, a model information update message, extracts, in operation 304, the update information and updates, in operation 306, the replicated model information. Depending upon the update format that the integrated GUI client specified in the demand information mapping rules that initiated the update message, the update information can consist of delta changes that are applied to the existing base of replicated model information, and/or replacement values for all or part of the information received from the remotes information source. The update format specified is configurable based upon many factors including network congestion, the number of updates expected during any given period of time, or number of updates expected as the result of common operational activities. Upon updating the replicated model information the GUI controller module is informed, in operation 308, that the update is complete and is informed of the time that the information changed at the remote information source. If the elapsed time since the information changed on the remote information source exceeds the acceptable update rule associated with the changed information component in GUI display mappings/update rules store, the GUI controller module will refresh, in operation 310, the GUI display with at least a portion of the newly received component values, otherwise, the new information is not immediately displayed.

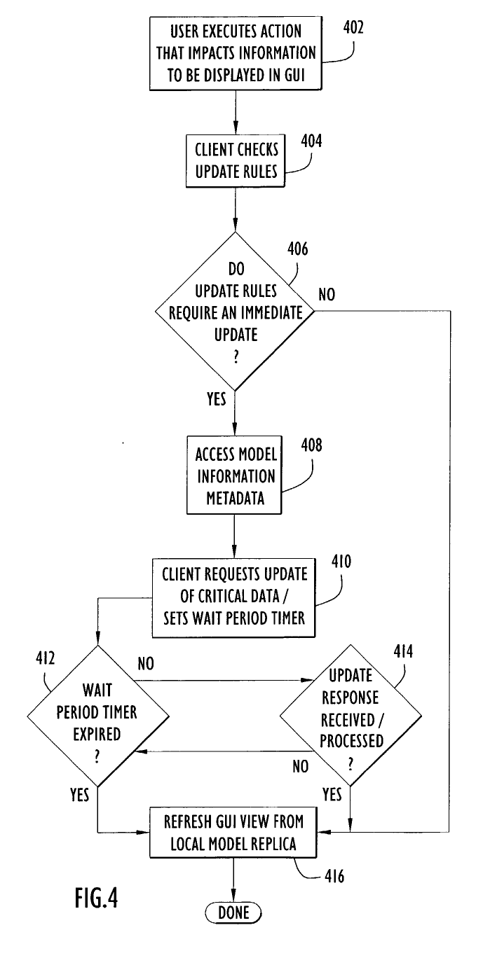

Under some circumstance, an integrated GUI client can request an immediate update from a remote information source. Such an information pull technique is used to assure that critical information displayed in an integrated GUI is as accurate as possible. For example, FIG. 4 is a non-limiting, representative flow chart illustrating a process associated with an integrated GUI display client initiating a pull of critical information from one or more remote information sources. First, the user executes, in operation 402, an action that impacts the information displayed in an integrated GUI display, thereby causing the GUI controller module to check, in operation 404, the update rules associated with the GUI components affected. If the update rules do not require, in operation 406, that the GUI display components be immediately updated from their respective remote information sources, the integrated GUI display is refreshed, in operation 416, from at least a portion of the locally stored replicated model information. However, if the update rules do require, in operation 406, that the GUI display components be immediately updated from their respective remote information sources, the GUI controller module accesses, in operation 408, the model information metadata for the critical components and generates, in operation 410, an update request to the each remote information source associated with a critical information component and sets a user configurable, information pull response timer. If the response timer expires, in operation 412, or all update responses are received and processed, in operation 414, the integrated GUI display is refreshed, in operation 416, from at least a portion of the locally stored replicated model information.

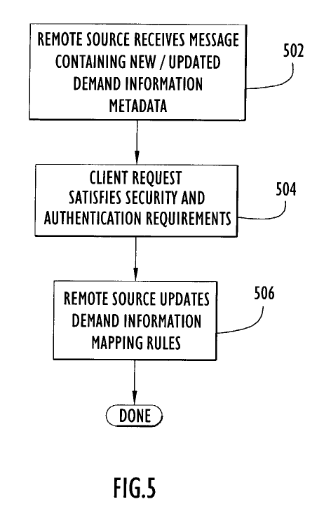

FIG. 5 is a non-limiting, representative flow chart illustrating a process associated with a remote information source receiving a demand for information updates from an integrated GUI client. First, a remote information source receives, in operation 502, a message from an integrated GUI client containing new or updated demand information metadata. Next, the model information replication module verifies, in operation 504, that the client request satisfies security and authentication requirements and, if it is determined that security requirements are satisfied, updates, in operation 506, the demand information mapping rules store.

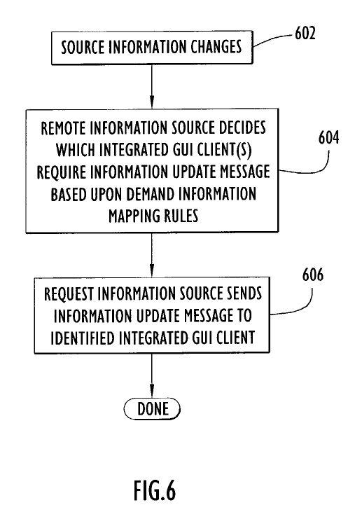

FIG. 6 is a non-limiting, representative flow chart illustrating a process associated with a remote information source diligently pushing information updates to one or more integrated GUI display clients, in response to changes in the model information store, in accordance with demand information mapping rules generated in response to demand requests received from the respective integrated GUI clients. First, the remote information source model information replication module detects, in operation 602, a change in the source information store. As previously described in relation to FIG. 1, the module information replication module searches, in operation 604, the demand information mapping rules to see if the changes affect any replicated model information stored upon an integrated GUI client with which it has an established data sharing relationship. If so, and update conditions for sending an update are met (as previously described with respect to Table 2), change information is formatted and transmitted, in operation 606, to the integrated GUI client identified in the respective demand information mapping rule. Depending upon the number of integrated GUI clients that have submitted demand information mapping rules for the affected information, the remote information source may generate and transmit multiple update messages based upon a single change, or set of changes, to its model information store. In this manner a single remote information source can support numerous integrated GUI displays associated with one or more applications on multiple integrated GUI clients from a single model information store.

It will be appreciated that the embodiments described above and illustrated in the drawings represent only a few of the many ways of implementing an integrated GUI display based upon replicated information established and maintained upon an integrated GUI client from one or more remote information sources.

The integrated GUI client and remote information source computer systems described here can be implemented by any quantity of any personal or other type of computer system (e.g., PC, APPLE MACINTOSH, laptop, palm pilot, PDA, etc.). The computer systems of the present invention can include any commercially available operating system. These computer systems can further include commercially available or custom software (e.g., server software, browser software, etc.), and various types of input devices (e.g., keyboard, mouse, voice recognition, etc.). It is to be understood that the software for these computer systems can be implemented in virtually any desired computer language and can be developed by one of ordinary skill in the computer arts based on the descriptions contained here and the flow charts illustrated in the drawings. The computer systems, alternatively, can be implemented by hardware or other processing circuitry. The various functions of the computer systems can be distributed in a variety of manners among practically any quantity of computer or processing systems or circuitry and/or among practically any quantity of software and/or hardware units or modules. The software and/or algorithms described above and illustrated in the flow charts can be modified in a manner that accomplishes the functions described herein.

The network can be implemented by practically any communications network (e.g., LAN, WAN, Internet, Intranet, etc.). The server and end-user computer systems can include any conventional or other communications devices to communicate over the network. The model information store and replicated model information stores can be implemented by practically any quantity of conventional or other databases, storage units or structures (e.g., file, data structure, etc.), can be arranged in practically any fashion and can store practically any desired information.

The remote information source modules, including the accompanying information stores, can be implemented by practically any quantity of computer systems, and can reside on a server, end-user or other third-party computer system or practically any combination of these computer systems. The integrated GUI display client can support any number of integrated GUI display in support of any number of applications that support integrated GUI displays. The integrated GUI client 102 and information source 104 modules can be stored on recorded medium (e.g., floppy diskettes, CD-ROM, memory devices, etc.) for loading on stand-alone systems or systems connected by a network, or can be downloaded (e.g., in the form of carrier waves, packets, etc.) to systems from a network.

The model information stores, demand information mapping rules, replicated model information stores GUI display mappings/update rules and model information metadata can be implemented using any information storage structures on any information storage device.

Update messages containing updates to replicated model information can be structured using any message format structure and may be transmitted using any number of network communication protocols and are not limited to asynchronous communication techniques and protocols. For example, updates to replicated model information can be performed using synchronous communication protocols between a remote information source and one or more integrated GUI clients, without significant impact upon integrated GUI performance and capabilities.

The present invention is not limited to the specific applications disclosed herein, but can be used in substantially the same manner described above to improve performance of any application that can be modified to operate using a local, replicated information store, rather than remote stores accessed across a network.

Having described methods and apparatuses related to the operation and use of an integrated GUI client with improved performance characteristics and a remote information source with diligent push capabilities, it is believed that other modifications, variations and changes will be suggested to those skilled in the art in view of the teachings set forth herein. It is therefore to be understood that all such variations, modifications and changes are believed to fall within the scope of the present invention as defined by the appended claims. Although specific terms are employed herein, they are used in their ordinary and accustomed manner only, unless expressly defined differently herein, and not for purposes of limitation.

What is claimed is:

1. A method of enhancing performance of a recipient's graphical user interface that displays information originating from at least one of a plurality of information sources, the method comprising:
sending a demand request from a requestor to at least one of the information sources requesting an asynchronous update message, wherein the demand request includes metadata referring to a model;
receiving at the recipient an asynchronous update message from said at least one of the plurality of the information sources containing information related to the model for display by the recipient graphical user interface;
storing at the recipient the information related to the model received in the asynchronous update message; and
retrieving at least a portion of said stored information for display via the recipient graphical user interface.

2. The method of claim 1, wherein the metadata includes an identifier for the recipient and wherein the metadata is used by said at least one of the information sources to build a demand information mapping rule that associates the recipient with a subset of information stored on said information source for which the recipient is to receive the asynchronous update message.

3. The method of claim 2, wherein said at least one of the information sources sends the asynchronous update message in response to a change in a source information store associated with the information source based upon the demand information mapping rules.

4. The method of claim 2, wherein said at least one of the information sources sends the asynchronous update message in response to satisfaction of a demand information mapping rule.

5. The method of claim 1, wherein the demand request further includes authentication data used by said at least one of the information sources to determine whether the update message requested in the metadata violates a security requirement.

6. The method of claim 1, wherein the metadata includes at least one of: an identifier for the recipient; an indicator of the urgency of the update message; a separation time between update messages; a definition of an event that triggers an update message; a content format for the update message; and a description of a subset of information stored on said at least one of the information sources for which the recipient is to receive the asynchronous update message.

7. The method of claim 1, wherein the demand request specifies that the update message to be received by the recipient contains change information associated with the model.

8. The method of claim 1, wherein the recipient information store further includes a plurality of update rules that govern when information displayed within a graphical user interface is updated.

9. The method of claim 8, wherein the plurality of update rules are configurable by a user to control presentation of information via the recipient graphical user interface.

10. The method of claim 8, wherein the asynchronous update message includes a time stamp that indicates when a change on the information source occurred and wherein the time stamp is used in conjunction with the plurality of update rules stored on the recipient to control display of information via the recipient graphical user interface.

11. The method of claim 10, wherein a portion of the information received in the timestamp is displayed via the recipient graphical user interface.

12. An article of manufacture comprising a computer program carrier readable by a computer and embodying one or more instructions executable by the computer for enhancing performance of a recipient's graphical user interface, wherein the recipient graphical user interface displays information originating from at least one of a plurality of information sources, said computer program comprising:
program instructions for sending a demand request from a requestor to at least one of the information sources requesting an asynchronous update message, wherein the demand request includes metadata referring to a model;
program instructions for receiving at the recipient an asynchronous update message from said at least one of the information sources containing information related to the model for display by the recipient graphical user interface;
program instructions for storing at the recipient the information related to the model received in the asynchronous update message; and
program instructions for retrieving at least a portion of said stored information for display via the recipient graphical user interface.

13. The article of manufacture of claim 12, wherein the metadata includes an identifier for the recipient and wherein the metadata is used by said at least one of the information sources to build a demand information mapping rule that associates the recipient with a subset of information stored on said information source for which the recipient is to receive the asynchronous update message.

14. The article of manufacture of claim 13, wherein said at least one of the information sources sends the asynchronous update message in response to a change in a source information store associated with the information source based upon the demand information mapping rules.

15. The article of manufacture of claim 13, wherein said at least one of the information sources sends the asynchronous update message in response to satisfaction of a demand information mapping rule.

16. The article of manufacture of claim 12, wherein the demand request further includes authentication data used by said at least one of the information sources to determine whether the update message requested in the metadata violates a security requirement.

17. The article of manufacture of claim 12, wherein the metadata includes at least one of: an identifier for the recipient; an indicator of the urgency of the update message; a separation time between update messages; a definition of an event that triggers an update message; a content format for the update message; and a description of a subset of information stored on said at least one of the information sources for which the recipient is to receive the asynchronous update message.

18. The article of manufacture of claim 12, wherein the demand request specifies that the update message to be received by the recipient contains change information associated with the model.

19. The article of manufacture of claim 12, wherein the recipient information store further includes a plurality of update rules that govern when information displayed within a graphical user interface is updated.

20. The article of manufacture of claim 19, wherein the plurality of update rules are configurable by a user to control presentation of information via the recipient graphical user interface.

21. The article of manufacture of claim 19, wherein the asynchronous update message includes a time stamp that indicates when a change on the information source occurred and wherein the time stamp is used in conjunction with the plurality of update rules stored on the recipient to control display of information via the recipient graphical user interface.

22. The article of manufacture of claim 21, wherein a portion of the information received in the timestamp is displayed via the recipient graphical user interface.

23. A method of enhancing performance of a recipient's graphical user interface that displays information originating from at least one of a plurality of information sources, the method comprising:
receiving at an information source a demand request from a requestor that refers to a model and requests an asynchronous update message;
building a demand information mapping rule based upon information received in the demand request; and
sending an asynchronous update message to the recipient in response to a change in information associated with the model held in a source information store on the information source, wherein the recipient is identified based upon the demand information mapping rule.

24. The method of claim 23, wherein the demand request includes metadata referring to the model that is used by the information source to build said demand information mapping rule.

25. The method of claim 23, wherein the metadata includes at least one of: an identifier for the recipient; an indicator of the urgency of the update message; a separation time between update messages; an event that triggers an update message; a content format for the update message; and a description of a subset of information stored on said information source for which the recipient is to receive the asynchronous update message.

26. The method of claim 23, wherein the demand request further includes authentication data that is used by the information source to determine whether the update message requested in the metadata violates a security requirement.

27. The method of claim 23, wherein the demand request specifies that the update message to be received by the recipient contains change information of the model.

28. The method of claim 23, wherein the asynchronous update message is sent by the information source in response to a change in a source information store that satisfies a demand information mapping rule.
